(19) United States
(12) Patent Application Publication
(10) Pub. No.: US 2026/0285415 A1
(43) Pub. Date: Sep. 24, 2026

(54) WHEEL LINER STABILIZING BRACKET AND VEHICLE INCLUDING SAME

(71) Applicant: NISSAN NORTH AMERICA, INC., Franklin, TN (US)

(72) Inventors: Ryan OSTRANDER, Grand Blanc, MI (US); Tatsuya HAYAKAWA, Novi, MI (US)

(21) Appl. No.: 19/085,991

(22) Filed: Mar. 20, 2025

(51) Int. Cl. B62D 25/16

(52) U.S. Cl. CPC B62D 25/163

(57) ABSTRACT

The present disclosure provides a vehicle with a wheel liner stabilizing bracket. In an embodiment, the vehicle includes a vehicle body, a plurality of wheels, a wheel liner, an undercarriage part and a wheel liner stabilizing bracket. The plurality of wheels are located on a lower side of the vehicle body. The wheel liner is positioned to at least partially surround at least a rear side of a wheel of the plurality of wheels and serve as a splash guard. The undercarriage part is located rear of the wheel and the wheel liner on the lower side of the vehicle body. The undercarriage part configured to provide a shield for one or more other undercarriage parts located on the lower side of the vehicle body. The wheel liner stabilizing bracket has a first end attached to the wheel liner and a second end attached to the undercarriage part.

### BACKGROUND

### Technical Field

The present disclosure generally relates to a wheel liner stabilizing bracket for a vehicle. The present disclosure also generally relates to a vehicle including a plurality of undercarriage parts positioned and arranged to support a wheel liner.

### Background Information

Most vehicles generally include wheel liners to prevent water, mud, rocks and other debris from being splashed or thrown by the wheels into the vehicle's undercarriage. Many wheel liners are flexible and wear away as they rub against tires after prolonged use, thus allowing increased amounts of liquid and debris to rust and corrode undercarriage parts such as air conditioning lines as time goes on. This issue is particularly evident in larger vehicles equipped with larger relative tires.

### SUMMARY

The present disclosure provides a vehicle and a wheel liner stabilizing bracket configured to stabilize a wheel liner. The disclosed wheel liner stabilizing bracket is advantageous, for example, because it prevents the wheel liner from flexing forward and rubbing against a rotating vehicle tire and/or flexing backward and creating a space that allows liquid and debris into the vehicle's undercarriage.

In view of the state of the known technology, one aspect of the present disclosure is to provide a vehicle. The vehicle includes a vehicle body, a plurality of wheels, a wheel liner, an undercarriage part, and a wheel liner stabilizing bracket. The plurality of wheels are located on a lower side of the vehicle body. The wheel liner is positioned to at least partially surround at least a rear side of a wheel of the plurality of wheels and serve as a splash guard for the wheel. The undercarriage part is located rear of the wheel and the wheel liner on the lower side of the vehicle body. The undercarriage part is configured to provide a shield for one or more other undercarriage parts located on the lower side of the vehicle body. The wheel liner stabilizing bracket has a first end attached to the wheel liner and a second end attached to the undercarriage part.

A second aspect of the present disclosure is to provide another embodiment of a vehicle. The vehicle includes a vehicle body, a plurality of wheels, a wheel liner, an undercarriage part, and a wheel liner stabilizing bracket. The plurality of wheels are located on a lower side of the vehicle body. The wheel liner is positioned to at least partially surround at least a rear side of a wheel of the plurality of wheels and serve as a splash guard for the wheel. The undercarriage part is located rear of the wheel and the wheel liner on the lower side of the vehicle body. The undercarriage part is directly attached to the wheel liner at a first attachment point. The wheel liner stabilizing bracket is directly attached to the wheel liner at a second attachment point and directly attached to the undercarriage part at a third attachment point.

A third aspect of the present disclosure is to provide a wheel liner stabilizing bracket designed to stabilize an inboard edge of a wheel liner. The wheel liner stabilizing bracket includes an elongated body, a first end and a second end. The first end is angled relative to a center portion of the elongated body at a first acute angle and includes a first aperture positioned and arranged to attach to the inboard edge of the wheel liner. The second end is also angled relative to the center portion of the elongated body at a second acute angle and includes a second aperture positioned and arranged to attach to an undercarriage part.

Other objects, features, aspects and advantages of the systems and methods disclosed herein will become apparent to those skilled in the art from the following detailed description, which, taken in conjunction with the annexed drawings, discloses exemplary embodiments of the disclosed systems and methods.

### BRIEF DESCRIPTION OF THE DRAWINGS

Referring now to the attached drawings which form a part of this original disclosure:

FIG. 1 illustrates a bottom perspective view of an example embodiment of a vehicle constructed in accordance with the present disclosure;

FIG. 2 illustrates a detailed bottom perspective view of certain undercarriage parts in the area A shown in FIG. 1 from an inboard perspective;

FIG. 3 illustrates another detailed bottom perspective view of certain undercarriage parts in the area A shown in FIG. 1 from an inboard perspective;

FIG. 4 illustrates another detailed bottom perspective view of certain undercarriage parts in the area A shown in FIG. 1 from an inboard perspective;

FIG. 5 illustrates another detailed bottom perspective view of certain undercarriage parts in the area A shown in FIG. 1 from an inboard perspective;

FIG. 6 illustrates a detailed bottom perspective view of certain undercarriage parts in the area A shown in FIG. 1 from an outboard perspective;

FIG. 7 illustrates another detailed bottom perspective view of certain undercarriage parts in the area A shown in FIG. 1 from an outboard perspective;

FIG. 8 illustrates a detailed top perspective view of certain undercarriage parts in the area A shown in FIG. 1 from an outboard perspective;

FIG. 9 illustrates a perspective view of a wheel liner stabilizing bracket constructed in accordance with the present disclosure;

FIG. 10 illustrates an opposite perspective view of the wheel liner stabilizing bracket shown in FIG. 9; and

FIG. 11 illustrates a side plan view of the wheel liner stabilizing bracket shown in FIG. 9.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

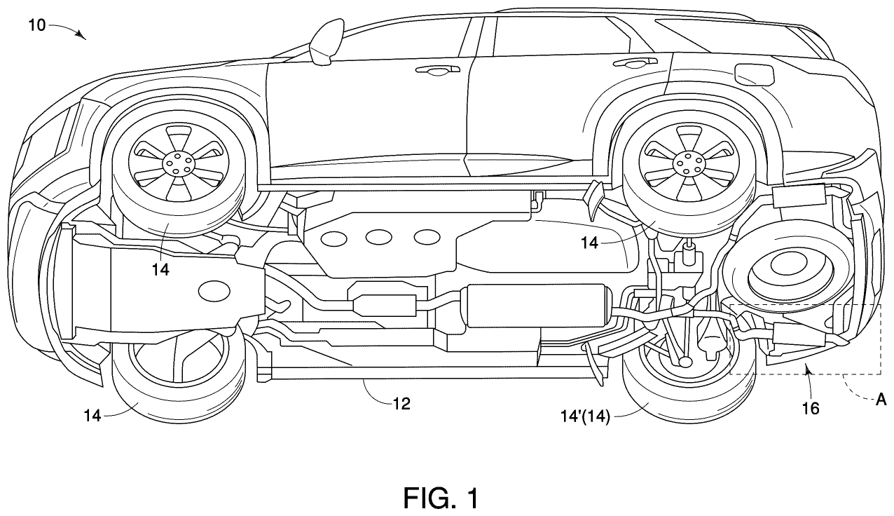

FIG. 1 illustrates an example embodiment of a vehicle 10 constructed in accordance with the present disclosure. The vehicle 10 includes a vehicle body 12, a plurality of wheels 14 located on the lower side of the vehicle body 12, and a plurality of undercarriage parts 16 attached on the lower side of the vehicle body 12. Since the lower side of the vehicle body 14 is generally uncovered, the undercarriage parts 16 are particularly susceptible to corrosion or damage by liquids or debris on a driving surface such as a road.

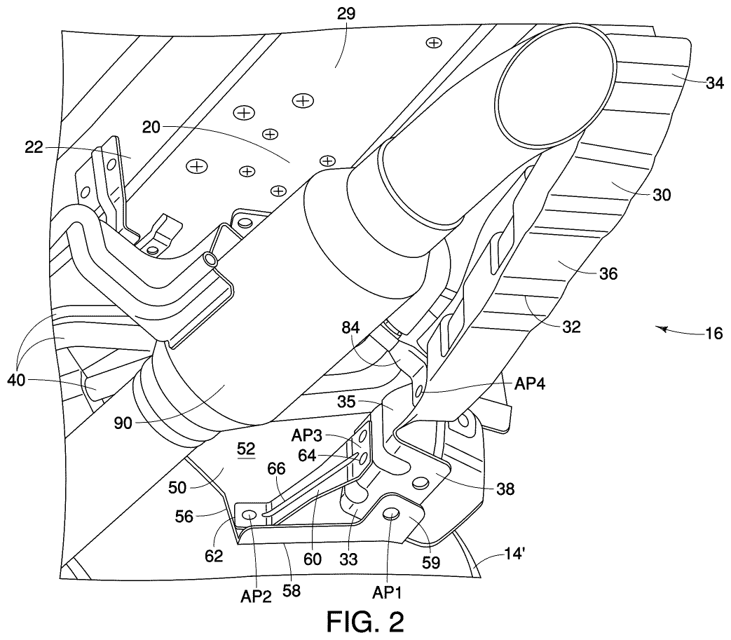

FIG. 1 shows the lower side of the vehicle 10 along with an area A behind the rear passenger side wheel 14′. FIGS. 2 to 8 show certain of the undercarriage parts 16 in the area A in more detail. In FIGS. 2 to 8, the undercarriage parts 16 generally include a drafter duct 20, a guard drafter 30, one or more air conditioning lines 40, a wheel liner 50, a wheel liner stabilizing bracket 60, an additional bracket 84, and a tail pipe 90.

As discussed in more detail below, the drafter duct 20, the guard drafter 30, the wheel liner 50 and the wheel liner stabilizing bracket 60 are attached to each other, either directly or indirectly, at a plurality of attachment points AP1, AP2, AP3, AP4, AP5, AP6, AP7. Those of ordinary skill in the art will recognize from this disclosure that the structures disclosed herein can also be applied to other wheel areas of the vehicle 10 besides behind the rear passenger side wheel 14′, and that certain of the undercarriage parts 16 and the attachment points AP1, AP2, AP3, AP4, AP5, AP6, AP7 can be altered or omitted, while still utilizing the same principles to achieve the objectives of the present disclosure, namely, to stabilize a wheel liner 50 behind a wheel 14 using a wheel liner stabilizing bracket 60.

Each wheel 14 generally includes a front side, a rear side, a bottom side and a top side. As the wheels 14 rotate while the vehicle 10 travels in the forward direction, the wheels 14 tend to pick up water or debris on the bottom side that contacts the ground surface and project the water or debris from the rear side and potentially above the top side into the undercarriage of the vehicle 10.

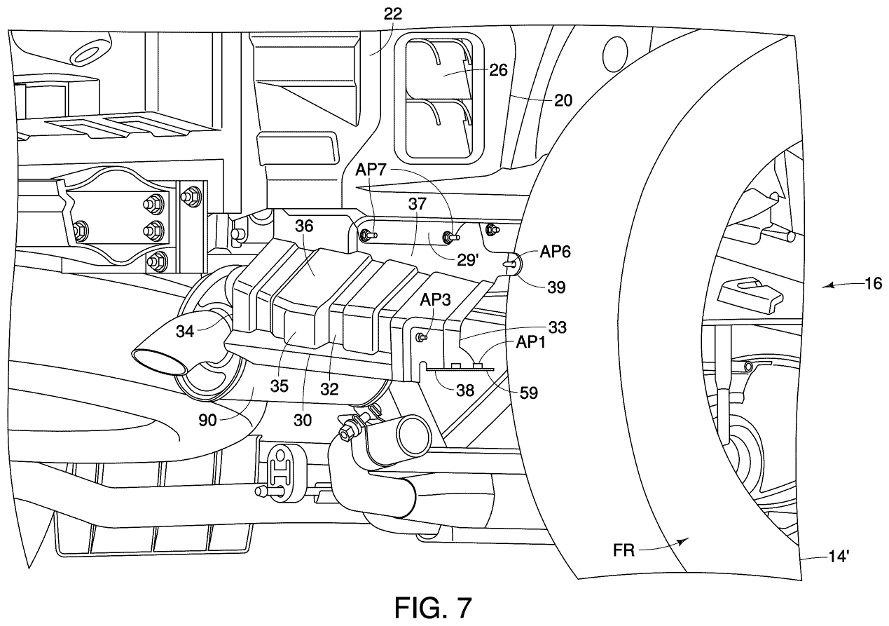

As seen in FIGS. 2 to 8, the drafter duct 20 is one of the plurality of undercarriage parts 16. In the illustrated embodiment, the drafter duct 20 is generally located above and rear of the wheel 14′. The drafter duct 20 is configured to enable air blown into the passenger compartment of the vehicle 10 to vent outside of the passenger compartment, which prevents pressurization of the passenger compartment and makes it easier to open and close the doors of the vehicle 10. The drafter duct 20 generally includes an elongated body 22 having an air flow passage 24 extending therethrough. As seen in FIGS. 7 and 8, the drafter duct 20 also includes a drafter vent 26 in air flow communication with the air flow passage 24. The drafter vent 26 is generally configured to enable air to escape the passenger compartment into the outside environment, and to prevent air from the outside environment from moving into the passenger compartment. That is, when air pressure within the passenger compartment is approximately the same or greater than the air pressure outside the vehicle 10, the drafter vent 26 opens to allow air to leave the passenger compartment. Otherwise, the drafter vent 26 closes to prevent air from entering the passenger compartment. The drafter duct 20 also includes a lower surface 28 which is attached to one or more other undercarriage parts 16 for stabilization in accordance with the present disclosure, as discussed in more detail below. In the illustrated embodiment, the drafter duct 20 is attached to a floor panel 29 of the vehicle body 12.

As seen in FIGS. 2 to 8, the guard drafter 30 is another of the plurality of undercarriage parts 16. In the illustrated embodiment, the guard drafter 30 is generally located rear of the wheel 14′ and the wheel liner 50 on the lower side of the vehicle body 12. The guard drafter 30 acts an extension of a floor panel underneath the vehicle 10. The guard drafter 30 is configured to provide a shield for one or more other undercarriage parts 16 on the lower side of the vehicle body 12. More specifically, the guard drafter 30 is configured to provide a shield for a drafter duct 20, for example, to prevent air expelled from the tail pipe 90 from entering the drafter duct 20.

The guard drafter 30 generally includes an elongated body 32 extending between a first end 33 and a second end 34. In the illustrated embodiment, the first end 33 is forward of the second end 34 in the direction of the vehicle body 12, and the elongated body 32 wraps around the rear passenger side of the vehicle 10 from the first end 33 to the second end 34.

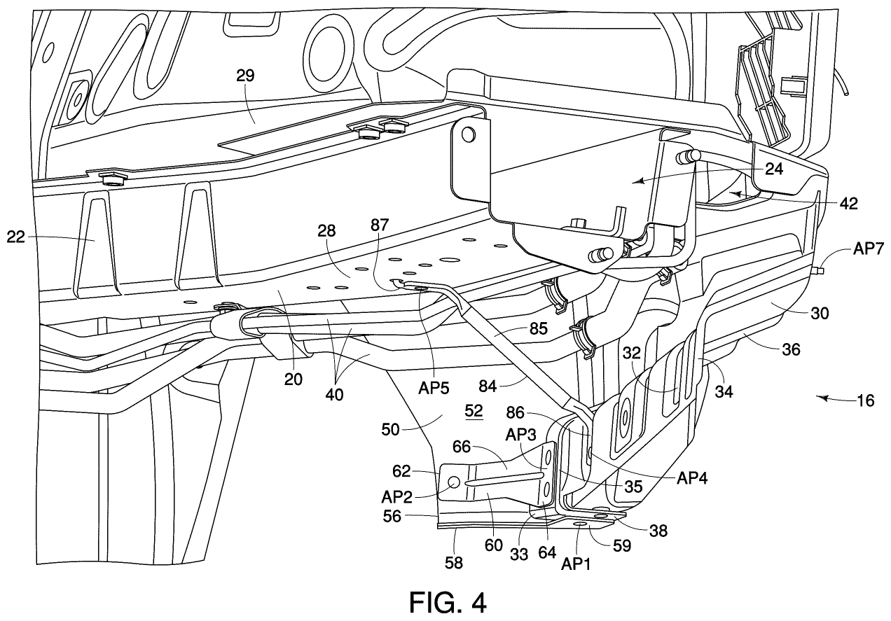

As best seen in FIGS. 4 to 6 and 8, the elongated body 32 includes a first lateral surface 35, a second lateral surface 36 and a third lateral surface 37. The first lateral surface 35, the second lateral surface 36 and the third lateral surface 37 generally extend from the first end 33 to the second end 34. Here, the first lateral surface 35 and the third lateral surface 37 are generally vertical surfaces, and the second lateral surface 35 is a generally angled or generally horizontal surface connecting the first lateral surface 35 and the third lateral surface 37 so that the first lateral surface 35 and the third lateral surface 37 are offset vertically and horizontally.

The guard drafter 30 further includes a first connecting surface 38 and a second connecting surface 39. As seen in FIGS. 2 to 8, the first connecting surface 38 extends in the outboard direction from a lower edge of the first lateral surface 35 at the first end 33 and is a generally horizontal surface connecting to a corresponding surface of the wheel liner 50 at the first attachment point AP1. As best seen in FIG. 8, the second connecting surface 39 extends in the outboard direction from a side edge the third lateral surface 37 at the first end 33 and is a generally vertical surface connecting to a corresponding surface of the wheel liner 50 at the sixth attachment point AP6. As discussed in more detail below, the first lateral surface 35 also attaches to the wheel liner stabilizing bracket 60 at the third attachment point AP1 to enable the wheel liner stabilizing bracket 60 to stabilize the wheel liner 50.

As seen in FIGS. 2 to 4, the air conditioning lines 40 are another of the plurality of undercarriage parts 16. The air conditioning lines 40 are elongated hollow pipes that introduce cooled air into the passenger compartment of the vehicle 10. The air conditioning lines extend in the rearward direction and upward into an aperture 42 in a floor panel 29 of the vehicle body 12. In an embodiment, the air conditioning lines 40 are placed in air flow communication with the drafter duct 20. The air conditioning lines 40 are typically made of a metal material that is susceptible to rust and corrosion if the wheel liner 50 deteriorates over time or otherwise fails to shield the undercarriage of the vehicle 10 from liquid and debris.

As seen in FIGS. 2 to 8, the wheel liner 50 is another of the plurality of undercarriage parts 16. The wheel liner 50 is generally located rear of the wheel 14′ and serves as a splash guard to prevent the wheel 14′ from projecting liquid and debris upwards and rearwards towards the undercarriage parts 16 in the area A behind the wheel 14′. More specifically, the wheel liner 50 is positioned to at least partially surround at least the rear side of the wheel 14′ and serve as a splash guard for the undercarriage parts 16 on the rear side of the wheel 14′. The wheel liner 50 can also be positioned to at least partially surround the top side of the wheel 14′ and serve as a splash guard for the undercarriage parts 16 located above the wheel 14′. The wheel liner 50 can also be positioned to at least partially surround the front side of the wheel 14′ and serve as a splash guard for the undercarriage parts 16 located forward of the wheel 14′.

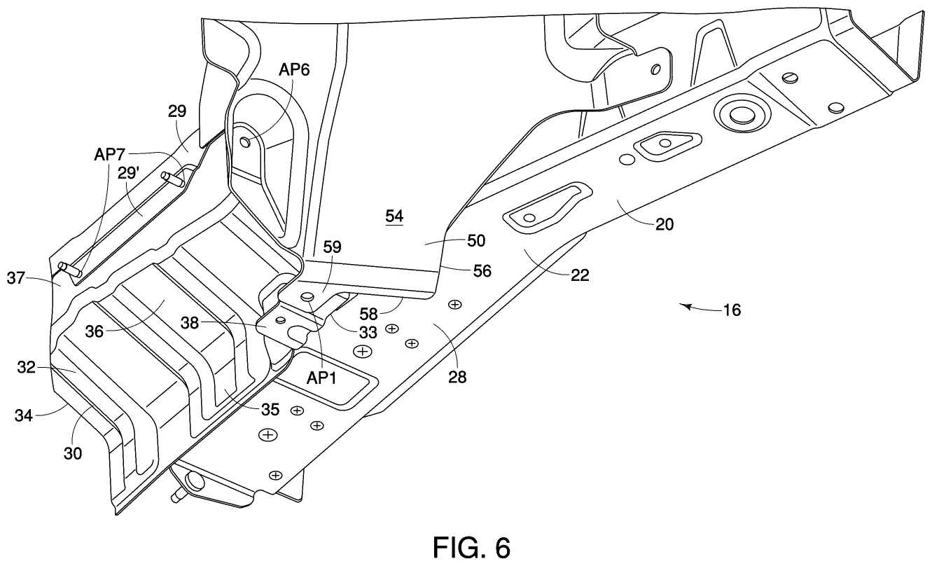

The wheel liner 50 generally includes in a first surface 52 and an opposite second surface 54 which extend inboard adjacent the wheel 14′. As seen in FIGS. 2 to 5, the first surface 52 is generally located on the inboard side of the vehicle 10. More specifically, the first surface 52 faces the drafter duct 20, the guard drafter 30, the air conditioning lines 40, the wheel liner stabilizing bracket 60, the additional bracket 84 and the tail pipe 90. As seen in FIG. 6, the opposite second surface 54 generally faces the wheel 14′. When the wheel 14′ splashes water and debris from a road surface towards the rear side of the vehicle 10, the water and debris generally contact the second surface 54.

The wheel liner 50 further includes an inboard edge 56 and a bottom edge 58 having a connecting surface 59. As seen in FIG. 6, the connecting surface 59 extends generally rearward from the bottom edge 58 in the direction of the vehicle body 12 and is a generally horizontal surface connecting to a corresponding surface of the guard drafter 30. That is, the first connecting surface 38 of the guard drafter 30 attaches to the connecting surface 59 at the first attachment point AP1. As seen in FIGS. 2 to 5, the wheel liner stabilizing bracket 60 attaches against the first surface 52 of the wheel liner 50 at the second attachment point AP2 proximal the inboard edge 56 of the wheel liner 50.

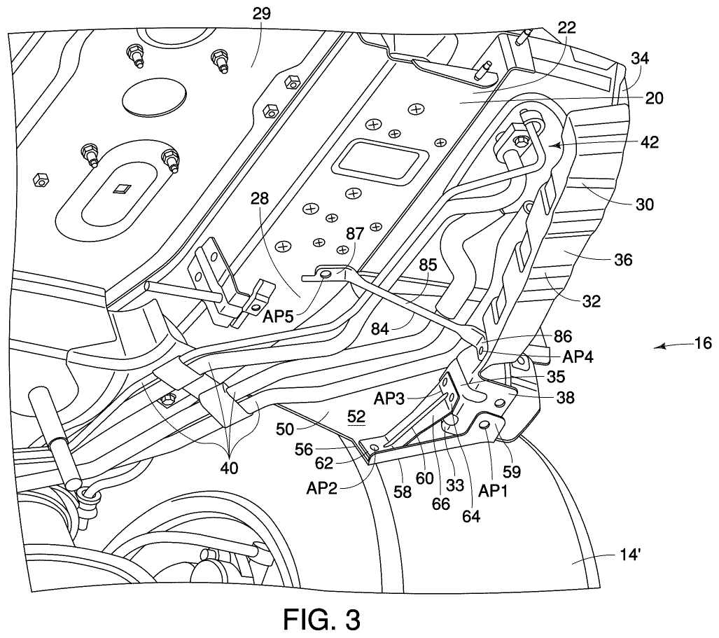

As seen in FIGS. 2 to 5, the wheel liner stabilizing bracket 60 is another of the plurality of undercarriage parts 16. The wheel liner stabilizing bracket 60 is designed to stabilize the inboard edge 56 of the wheel liner 50 behind the wheel 14′. The wheel liner stabilizing bracket 60 stabilizes the inboard edge 56 of the wheel liner 50 to prevent the wheel liner 50 from flexing forward and rubbing against the wheel 14′ and/or flexing rearward to create a space that allows liquid and debris into the undercarriage of the vehicle 10 behind the wheel 14′. As seen in FIGS. 3 and 4, the wheel liner stabilizing bracket 60 is located below the air conditioning lines 40 and is configured to prevent water and debris from being projected by the wheel 14′ onto the air conditioning lines 40.

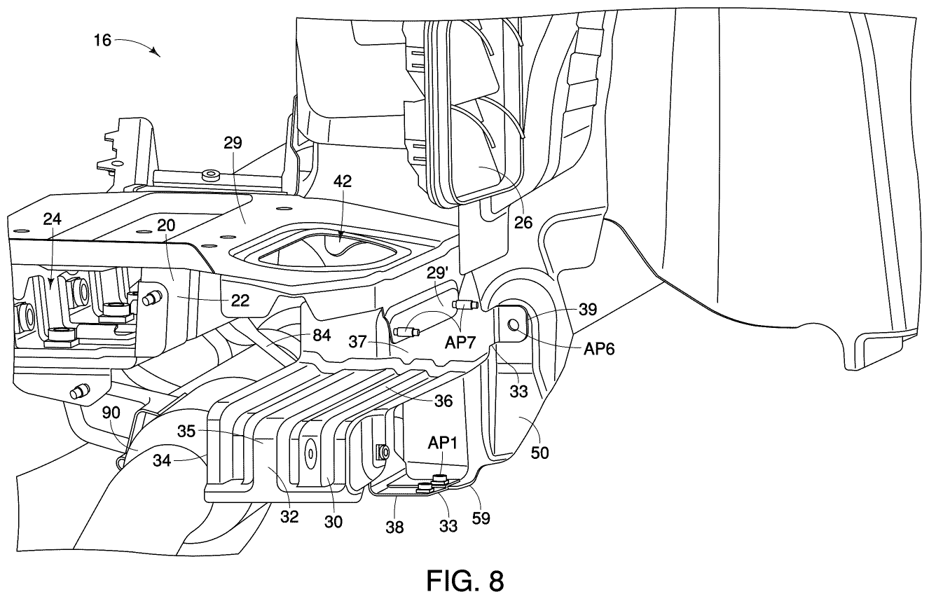

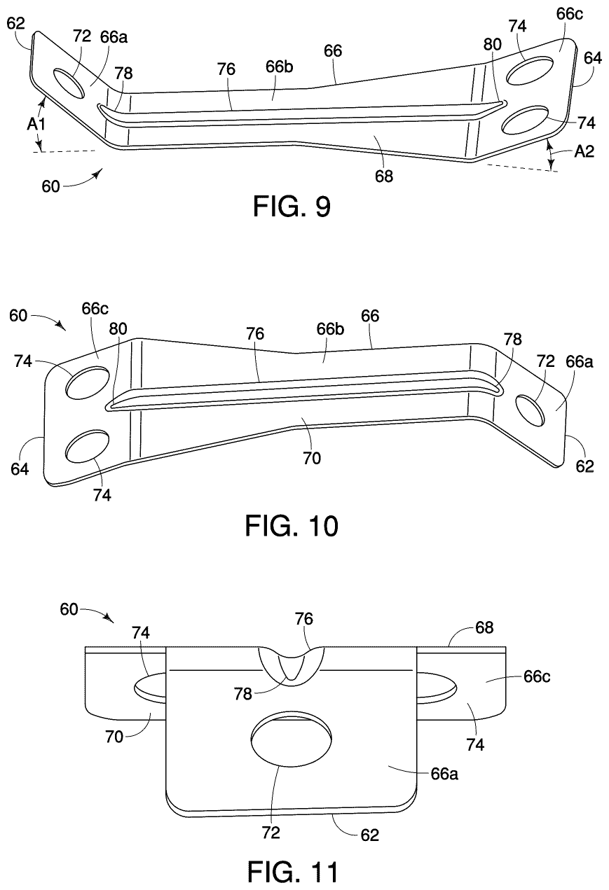

FIGS. 9 to 11 illustrate the wheel liner stabilizing bracket 60 in more detail. The wheel liner stabilizing bracket 60 generally includes a first end 62, a second end 64 and an elongated body 66. The first end 62 is configured to attach to one undercarriage part 16, and the second end 64 is configured to attach to a different undercarriage part 16. In the illustrated embodiment, the first end 62 is configured to attach to the wheel liner 50, and the second end 64 is configured to attach to the guard drafter 30. More specifically, the first end 62 is attached to the wheel liner 50 at the inboard edge 56 of the wheel liner 50, while the second end 64 is attached to the first lateral surface 35 at the first end 33 of the guard drafter 30. In the illustrated embodiment, the second end 64 is wider than the first end 62.

In the illustrated embodiment, the elongated body 66 is generally flat. The generally flat elongated body 66 connects the first end 62 and the second end 64. The generally flat elongated body 66 further includes a first side surface 68 and an opposite second side surface 70. When the wheel liner stabilizing bracket 60 is attached to the guard drafter 30 and the wheel liner 50 as seen in FIGS. 2 to 8, the angled portion of the second side surface 70 at the first end 62 contacts the first surface 52 of the wheel liner 50 at the inboard edge 56, and the angled portion of the second side surface 70 at the second end 64 contacts the first lateral surface 35 of the guard drafter 30 at the first end 33. In the illustrated embodiment, the elongated body 66 is approximately 0.7 mm thick between the first side surface 68 and the second side surface 70, approximately 25 mm wide at the first end 62, and approximately 42 inches wide at the second end 64.

At least one of the first end 62 and the second end 64 are angled. More specifically, the elongated body 66 includes a first portion 66a, a second portion 66b and a third portion 66c. In the illustrated embodiment, the first end 62 is angled in the opposite direction of the second end 64 relative to the elongated body 66. The first end 62 of the wheel liner stabilizing bracket 60 is angled at a first acute angle A1 relative to the elongated body 66. In other words, the first portion 66a of the elongated body 66 at the first end 62 is angled at the first acute angle A1 relative to the second portion 66b. The second end 64 of the wheel liner stabilizing bracket 60 is angled at a second acute angle A2 relative to the elongated body 66. In other words, the third portion 66c of the elongated body 66 is angled at the second acute angle A2 relative to the second portion 66b. The first acute angle A1 is larger than the second acute angle A2. The first acute angle A1 is angled between about 40 and 50 degrees relative to the second portion 66b of the elongated body 66, or more particularly between about 42 and 47 degrees, or even more particularly about 44 to 45 degrees. The second acute angle A2 is angled between about 10 and 25 degrees relative to the second portion 66b of the elongated body 66, or more particularly between about 15 and 20 degrees, or even more particularly about 18 to 19 degrees.

In the illustrated embodiment, the first end 62 includes at least one first aperture 72 configured attach to the inboard edge 56 of the wheel liner 50. The second end 64 includes at least one second aperture 74 configured to attach to a different undercarriage part 16. More specifically, the second end 64 includes two second apertures 74 configured to attach to a different undercarriage part 16. Here, the different undercarriage part 16 is the guard drafter 30. The two second apertures 74 at the at the second end 64 of the wheel liner stabilizing bracket 60 connect the wheel liner stabilizing bracket 60 to the guard drafter 30 and also act as an anti-rotation feature that prevents the first end 62 and the inboard edge 56 of the wheel liner 50 attached thereto from moving vertically or otherwise rotating with respect to the third attachment point AP3 at the second end 64.

In the illustrated embodiment, the wheel liner stabilizing bracket 60 further includes a reinforcing rib 76 extending along the elongated body 66 in the length direction between the first end 62 and the second end 64. The reinforcing rib 76 is stamped into the elongated body 66 and extends from a first rib end 78 to a second rib end 80. More specifically, the rib 76 is stamped into the second side surface 70 to create a concave space in the second surface 70 and a convex surface in the first surface 68 between the first rib end 78 to the second rib end 80. As seen in FIGS. 9 and 10, the first end 78 extends at least partially into the angled portion of the first side surface 68 and the second side surface 70 at the first end 62, and the second end 80 extends at least partially into the angled portion of the first side surface 68 and the second side surface 70 at the second end 64. In other words, the reinforcing rib 76 extends through the entirety of the second portion 66b of the elongated body 66 at partially into the first portion 66a on one side and the third portion 66c on the other side.

In the illustrated embodiment, the wheel liner stabilizing bracket 60 is made of metal (e.g., steel), but the wheel liner stabilizing bracket 60 can also be made of other rigid materials such as a suitable plastic.

As seen in FIGS. 3 to 6, an additional or second bracket 84 is another of the plurality of undercarriages parts 16. The second bracket 84 has an elongated body 85 extending from a first end 86 to a second end 87. The first end 86 attaches to the guard drafter 30 at a fourth attachment point AP4. More specifically, the first end 86 attaches to the first lateral surface 35 of the guard drafter 30 at the fourth attachment point AP4. The second end 87 attaches to the drafter duct 20 at a fifth attachment point AP5. More specifically, the second end 87 attaches to the lower surface 28 of the drafter duct 20 at the fifth attachment point AP5.

As seen in FIGS. 2 and 8, the tail pipe 90 is another of the plurality of undercarriages parts 16. The tail pipe 90 extends rearward behind the wheel liner 50 and expels exhaust that is then blocked by the guard drafter 30 from entering the drafter duct 20 via the drafter vent 26. The tail pipe 90 is typically made of a metal material that is susceptible to rust and corrosion if the wheel liner 50 deteriorates over time or otherwise fails to shield the undercarriage of the vehicle 10 from liquid and debris.

FIGS. 2 to 8 also illustrate a plurality of attachment points where the plurality of undercarriage parts 16 directly or indirectly attach to each other. The attachment points AP1, AP2, AP3, AP4, AP5, AP6, AP7 include a first attachment point AP1, a second attachment point AP2, a third attachment point AP3, a fourth attachment point AP4, a fifth attachment point AP5, a sixth attachment point AP6 and a seventh attachment point AP7. The terms “first,” “second,” “third,” “fourth,” “fifth,” “sixth” and “seventh” are for reference only and can be applied to any of the attachment points AP1, AP2, AP3, AP4, AP5, AP6, AP7.

FIGS. 2 to 8 illustrate the location of the first attachment point AP1. The guard drafter 30 directly attaches to the wheel liner 50 at the first attachment point AP1. More specifically, the first connecting surface 38 at the first end 33 of the guard drafter 30 directly attaches to the connecting surface 59 of the wheel liner 50 at the first attachment point AP1. In the illustrated embodiment, the first attachment point AP1 is a generally vertical attachment point. That is, the corresponding attaching surfaces of the guard drafter 30 and the wheel liner 50 overlap vertically so that a connector can be inserted generally vertically through corresponding apertures to attach the two surfaces. The connector can include, for example, one or more of a screw, bolt, nut, clip, rivet and/or other mechanical connector.

As seen in FIGS. 2 to 8, the first attachment point AP1 is located vertically below the second attachment point AP1 and the third attachment point AP3. The first attachment point AP1 is also located vertically below the fourth attachment point AP4, the fifth attachment point AP5, the sixth attachment point AP6 and the seventh attachment point AP7. That is, the first attachment point AP1 is the lowest of the illustrated attachment points AP1, AP2, AP3, AP4, AP5, AP6, AP7 in the vertical direction. The first attachment point AP1 is also located rearward of the second attachment point AP2 in the lengthwise direction of the vehicle body 12, and is located forward of the fourth attachment point AP4 and the fifth attachment point AP5 in the lengthwise direction of the vehicle body 12. In the illustrated embodiment, the first attachment point AP1 is generally aligned with the third attachment point AP3 in the lengthwise direction of the vehicle body 12.

FIGS. 2 to 5 illustrate the location of the second attachment point AP2. The wheel liner stabilizing bracket 60 directly attaches to the wheel liner 50 at the second attachment point AP2. More specifically, the first end 62 (or first portion 66a) of the wheel liner stabilizing bracket 60 directly attaches to the inboard edge 56 of the wheel liner 50 at the second attachment point AP2. In the illustrated embodiment, the second attachment point AP2 is a generally horizontal attachment point. That is, the corresponding attaching surfaces of the wheel liner stabilizing bracket 60 and the wheel liner 50 overlap horizontally so that a connector can be inserted generally horizontally through corresponding apertures to attach the two surfaces. The connector can include, for example, one or more of a screw, bolt, nut, clip, rivet and/or other mechanical connector.

As seen in FIGS. 2 to 5, the second attachment point AP2 is located forward of the first attachment point AP1 and the third attachment point AP3 in the lengthwise direction of the vehicle body 12. The second attachment point AP2 is also located forward of the fourth attachment point AP4, the fifth attachment point AP5, the sixth attachment point AP6 and the seventh attachment point AP7 in the lengthwise direction of the vehicle body 12. That is, the second attachment point AP2 is the forwardmost of the illustrated attachment points AP1, AP2, AP3, AP4, AP5, AP6, AP7 in the lengthwise direction of the vehicle body 12.

FIGS. 2 to 5 and 7 illustrate the location of the third attachment point AP3. The wheel liner stabilizing bracket 60 directly attaches to the guard drafter 30 at the third attachment point AP3. More specifically, the second end 64 (or third portion 66c) of the wheel liner stabilizing bracket 60 directly attaches to the first end 33 of the first lateral surface 35 of the guard drafter 30 at the third attachment point AP3. In the illustrated embodiment, the third attachment point AP3 is a generally horizontal attachment point. That is, the corresponding attaching surfaces of the wheel liner stabilizing bracket 60 and the guard drafter 30 overlap horizontally so that a connector can be inserted generally horizontally through corresponding apertures to attach the two surfaces. The connector can include, for example, one or more of a screw, bolt, nut, clip, rivet and/or other mechanical connector. In the illustrated embodiment, the third attachment point AP3 includes two generally vertically aligned points (corresponding to the two second apertures 74) which assist in preventing the wheel liner stabilizing bracket 60 from rotating once attached to the guard drafter 30.

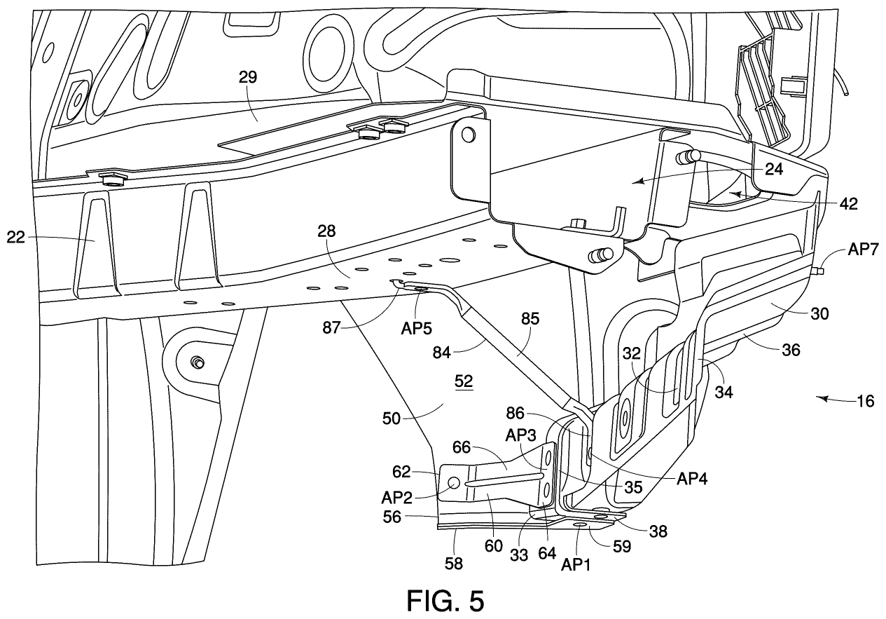

As seen in FIGS. 2 to 5, the third attachment point AP3 is located vertically above the first attachment point AP1 and vertically below the fifth attachment point AP5, the sixth attachment point AP6, and the seventh attachment point AP7. As best seen in FIGS. 4 and 5, the third attachment point AP3 is generally aligned with the second attachment point AP2 and the fourth attachment point AP4 in the vertical direction. The third attachment point AP3 is also located rearward of the second attachment point AP2 in the lengthwise direction of the vehicle body 12.

FIGS. 2 to 5 illustrate the fourth attachment point AP4. The second bracket 64 directly attaches to the guard drafter 30 at the fourth attachment point AP4. More specifically, the first end 86 of the second bracket 84 directly attaches to the first lateral surface 35 of the guard drafter 30 at the fourth attachment point AP4. In the illustrated embodiment, the fourth attachment point AP4 is a generally horizontal attachment point. That is, the corresponding attaching surfaces of the second bracket 64 and the guard drafter 30 overlap horizontally so that a connector can be inserted generally horizontally through corresponding apertures to attach the two surfaces. The connector can include, for example, one or more of a screw, bolt, nut, clip, rivet and/or other mechanical connector.

As seen in FIGS. 2 to 5, the fourth attachment point AP4 is located vertically above the first attachment point AP1 and vertically below the fifth attachment point AP5, the sixth attachment point AP6 and the seventh attachment point AP7. As best seen in FIGS. 4 and 5, the fourth attachment point AP4 is generally aligned with the second attachment point AP2 and the third attachment point AP3 in the vertical direction. The fourth attachment point AP4 is also located rearward of the first attachment point AP1, the second attachment point AP2 and the third attachment point AP3 in the lengthwise direction of the vehicle body 12.

FIGS. 3 to 5 illustrate the fifth attachment point AP5. The additional bracket 84 directly attaches to the drafter duct 20 at the fifth attachment point AP5. More specifically, the second end 87 of the bracket 84 directly attaches to the lower surface 28 of the drafter duct 20 at the fifth attachment point AP5. In the illustrated embodiment, the fifth attachment point AP5 is a generally vertical attachment point. That is, the corresponding attaching surfaces of the bracket 84 and the drafter duct 20 overlap vertically so that a connector can be inserted generally vertically through corresponding apertures to attach the two surfaces. The connector can include, for example, one or more of a screw, bolt, nut, clip, rivet and/or other mechanical connector.

As seen in FIGS. 3 to 5, the fifth attachment point AP5 is located vertically above the first attachment point AP1, the second attachment point AP2, the third attachment point AP3, and the fourth attachment point AP4, and is located vertically below the seventh attachment point AP7. The fifth attachment point AP5 is also located rearward of the first attachment point AP1, the second attachment point AP2 and the third attachment point AP3 in the lengthwise direction of the vehicle body 12.

FIGS. 6 and 8 illustrate the sixth attachment point AP6. The guard drafter 30 directly attaches to the wheel liner 50 at the sixth attachment point AP6. More specifically, the second connecting surface 39 of the guard drafter 30 directly attaches to the wheel liner 50 at the sixth attachment point AP6. In the illustrated embodiment, the sixth attachment point AP6 is a generally horizontal attachment point. That is, the corresponding attaching surfaces of the guard drafter 30 and the wheel liner 50 overlap horizontally so that a connector can be inserted generally horizontally through corresponding apertures to attach the two surfaces. The connector can include, for example, one or more of a screw, bolt, nut, clip, rivet and/or other mechanical connector.

As seen in FIGS. 6 and 8, the sixth attachment point AP6 is located vertically above the first attachment point AP1, the second attachment point AP2, the third attachment point AP3 and the fourth attachment point AP4. The sixth attachment point AP6 is located vertically below the seventh attachment point AP7. The sixth attachment point AP6 is also located forward of at least the first attachment point AP1, the third attachment point AP3, the fourth attachment point AP4 and the fifth attachment point AP5 in the lengthwise direction of the vehicle body 12.

FIGS. 6 to 8 illustrate the seventh attachment point AP7. The guard drafter 30 is directly attached to an extension 29′ of the floor panel 29 of the vehicle body 12 at the seventh attachment point AP7. In the illustrated embodiment, the seventh attachment point AP7 is a generally horizontal attachment point. That is, the corresponding attaching surfaces overlap horizontally so that a connector can be inserted generally horizontally through corresponding apertures to attach the two surfaces. The connector can include, for example, one or more of a screw, bolt, nut, clip, rivet and/or other mechanical connector. In the illustrated embodiment, the seventh attachment point AP7 includes two generally horizontally aligned points.

As seen in FIGS. 6 to 8, the seventh attachment point AP7 is located vertically above each of the first attachment point AP1, the second attachment point AP2, the third attachment point AP3, the fourth attachment point AP4, the fifth attachment point AP5 and the sixth attachment point AP6. That is, the seventh attachment point AP7 is the highest of the attachment points AP1, AP2, AP3, AP4, AP5, AP6, AP7 in the vertical direction.

In the illustrated embodiment, the vehicle 10 is an SUV. Although wheel liner deterioration from rubbing against wheels is particularly evident in large vehicles such as SUVs, those of ordinary skill in the art will recognize from this disclosure that the structures and assemblies disclosed herein can be applied to any type of vehicle 10.

The embodiments described herein provide improved support to vehicle wheel liners. These systems and methods are advantageous, for example, because they improve protection of undercarriage parts like the air conditioning lines from rusting and corroding. It should be understood that various changes and modifications to the systems and methods described herein will be apparent to those skilled in the art and can be made without diminishing the intended advantages.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

The term “configured” as used herein to describe a component, section or part of a device includes hardware that is constructed to carry out the desired function.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A vehicle comprising:
a vehicle body;
a plurality of wheels located on a lower side of the vehicle body;
a wheel liner positioned to at least partially surround at least a rear side of a wheel of the plurality of wheels and serve as a splash guard for the wheel;
an undercarriage part located rear of the wheel and the wheel liner on the lower side of the vehicle body, the undercarriage part configured to provide a shield for one or more other undercarriage parts located on the lower side of the vehicle body; and
a wheel liner stabilizing bracket having a first end attached to the wheel liner and a second end attached to the undercarriage part.

2. The vehicle of claim 1, wherein
the wheel liner stabilizing bracket includes a generally flat elongated body connecting the first end and the second end.

3. The vehicle of claim 2, wherein
the first end of the wheel liner stabilizing bracket is angled at a first acute angle relative to a center portion of the elongated body.

4. The vehicle of claim 2, wherein
the second end of the wheel liner stabilizing bracket is angled at a second acute angle relative to a center portion of the elongated body.

5. The vehicle of claim 1, wherein
the first end of the wheel liner stabilizing bracket is attached to the wheel liner at an inboard edge of the wheel liner.

6. The vehicle of claim 1, wherein
the first end of the wheel liner stabilizing bracket is attached to the wheel liner at a first attachment point,
the second end of the wheel liner stabilizing bracket is attached to the undercarriage part at a second attachment point, and
the wheel liner is directly attached to the undercarriage part at a third attachment point.

7. The vehicle of claim 1, wherein
the undercarriage part includes a guard drafter configured to provide the shield for a drafter duct.

8. A vehicle comprising:
a vehicle body;
a plurality of wheels located on a lower side of the vehicle body;
a wheel liner positioned to at least partially surround at least a rear side of a wheel of the plurality of wheels and serve as a splash guard for the wheel;
an undercarriage part located rear of the wheel and the wheel liner on the lower side of the vehicle body, the undercarriage part directly attached to the wheel liner at a first attachment point; and
a wheel liner stabilizing bracket directly attached to the wheel liner at a second attachment point and directly attached to the undercarriage part at a third attachment point.

9. The vehicle of claim 8, wherein
the undercarriage part is a guard drafter configured to provide a shield for a drafter duct.

10. The vehicle of claim 9, comprising
a second bracket directly attached to the drafter duct at a fourth attachment point and directly attached to the guard drafter at a fifth attachment point.

11. The vehicle of claim 8, wherein
the wheel liner stabilizing bracket has a first end attached to the wheel liner at the second attachment point and a second end attached to the undercarriage part at the third attachment point.

12. The vehicle of claim 10, wherein
the wheel liner stabilizing bracket includes a generally flat elongated body connecting the first end and the second end, and
at least one of the first end and the second end is angled relative to a center portion of the elongated body.

13. The vehicle of claim 8, wherein
the second attachment point is at an inboard edge of the wheel liner.

14. The vehicle of claim 8, comprising
at least one air conditioning line,
the wheel liner stabilizing bracket located below the at least one air conditioning line.

15. A wheel liner stabilizing bracket designed to stabilize an inboard edge of a wheel liner, the wheel liner stabilizing bracket comprising:
an elongated body;
a first end angled relative to a center portion of the elongated body at a first acute angle and including a first aperture positioned and arranged to attach to the inboard edge of the wheel liner; and
a second end angled relative to the center portion of the elongated body at a second acute angle and including a second aperture positioned and arranges to attach to an undercarriage part.

16. The wheel liner stabilizing bracket of claim 15, wherein
the second end includes two second apertures for attachment to the undercarriage part.

17. The wheel liner stabilizing bracket of claim 15, wherein
the first acute angle is larger than the second acute angle.

18. The wheel liner stabilizing bracket of claim 17, wherein
the first acute angle is angled between 40 and 50 degrees relative to the center portion of the elongated body, and the second acute angle is angled between 10 and 25 degrees relative to the center portion of the elongated body.

19. The wheel liner stabilizing bracket of claim 15, wherein
the first end is angled in the opposite direction of the second end relative to the center portion of the elongated body.

20. The wheel liner stabilizing bracket of claim 15, further comprising
a reinforcing rib extending along the elongated body between the first end and the second end.
